(19) United States
(12) Patent Application Publication
(10) Pub. No.: US 2021/0310301 A1
(43) Pub. Date: Oct. 7, 2021

(54) ROLL-UP DOORS

(71) Applicant: Clopay Corporation, Mason, OH (US)

(72) Inventor: Nathan J. Janiczek, Nanticoke, PA (US)

(21) Appl. No.: 16/839,561

(22) Filed: Apr. 3, 2020

(51) Int. Cl. E06B 9/58; E06B 9/13; E06B 9/68

(52) U.S. Cl. CPC E06B 9/581; E06B 2009/6809; E06B 9/68; E06B 9/13

(57) ABSTRACT

In example implementations, a roll-up door is provided. The roll-up door includes a shaft, a flexible curtain, a plurality of buttons along a first edge and a second edge of the flexible curtain, a first guide assembly to enclose the plurality of buttons along the first edge of the flexible curtain, and a second guide assembly to enclose the plurality of buttons along the second edge of the flexible curtain. A first end of the flexible curtain is coupled to the shaft. The plurality of buttons are to guide movement of the flexible curtain caused by rotation of the shaft.

### BACKGROUND

Roll-up doors are often used to form closures over openings in buildings, such as garages, warehouses, stores, etc. Such a roll-up door generally includes a flexible curtain which can be coiled and uncoiled from a shaft that is mounted at one end of the opening in order to open and close the opening. To close the opening, for example, the flexible curtain may be uncoiled from the shaft such that an end of the flexible curtain is extended away from the shaft toward an opposite end of the opening. Retracting the end of the flexible curtain toward the shaft by coiling the flexible curtain around the shaft uncovers the opening to allow access through the opening. For vertical doors, for example, the shaft may be mounted above the opening, and the end of the flexible curtain may be lowered toward the floor to close the opening or raised to uncover the opening.

The side edges of the flexible curtains are threaded into guides mounted along the lateral sides of the opening. Such guides are generally adapted to direct the flexible curtain as the flexible curtain is coiled and uncoiled and to help anchor the sides of the opening. A difficulty that may be encountered with typical roll-up doors is that the side edges of the flexible curtain can be pulled out of the guides during operation or, for example, when a force is applied against the flexible curtain in the closed position. When this occurs, the roll-up door is unable to provide proper closure of the opening.

### BRIEF DESCRIPTION OF THE DRAWINGS

FIG. 1 is a block diagram of an example roll-up door of the present disclosure;

FIG. 2 is a block diagram of a front view of an example flexible curtain of the roll-up door of the present disclosure;

FIG. 3 is a block diagram of a side view of an example flexible curtain of the roll-up door of the present disclosure;

FIG. 4 is a block diagram of an exploded view of an example button coupled to the flexible curtain of the roll-up door of the present disclosure;

FIG. 5 is a block diagram of a cross-sectional view of the example button coupled to the flexible curtain of the roll-up door of the present disclosure; and

FIG. 6 is a block diagram of a top view of the roll-up door and guide assembly of the present disclosure.

### DETAILED DESCRIPTION

Examples described herein provide examples of a roll-up door. Roll-up doors are often used to form closures over openings in buildings. Some roll-up doors can be used to provide smoke barriers in front of elevator doors in case of a fire. In this case, the roll-up door can be mounted over an elevator door.

As noted above, a difficulty with roll-up doors may be that the side edges of the flexible curtain can be pulled out of the guides during operation or, for example, when a force is applied against the flexible curtain in the closed position. When this occurs, the roll-up door is unable to provide proper closure of the opening.

The roll-up door of the present disclosure provides an improved flexible curtain that may be relatively more rigid compared to commercially available products. Thus, the flexible curtain of the present disclosure provides a longer lasting roll-up door that can withstand greater pressures and force in the closed position.

In addition, the improved flexible curtain allows smaller buttons to secure the flexible curtain within guides of the roll-up door. The flexible curtain can be manufactured with pre-cut openings where the buttons may be attached to allow for easy assembly and alignment of the roll-up door.

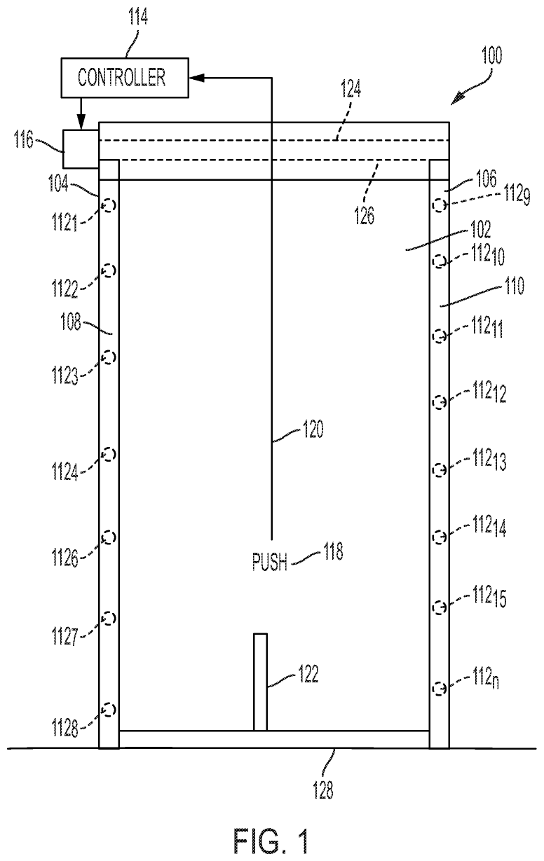

FIG. 1 illustrates an example roll-up door 100 of the present disclosure. In one embodiment, the roll-up door 100 may be deployed in front of an elevator door in a building. However, it should be noted that the roll-up door 100 may be mounted over any type of opening.

In one embodiment, the roll-up door 100 may include a flexible curtain 102 coupled to a shaft 124 in a housing mounted over a top of an opening or elevator door. The roll-up door 100 may also include a first guide assembly 104 and a second guide assembly 106. In one embodiment, a first end 126 of the flexible curtain can be coupled to the shaft 124. The shaft may be approximately three inches in diameter.

In one embodiment, the shaft 124 may be coupled to a motor 116. The motor 116 may be coupled to a controller 114 that may control operation of the motor 116. Although FIG. 1 illustrates the motor 116 and the controller 114 outside of a housing of the shaft 124, it should be noted that the motor 116, the controller 114, and the shaft 124 may be located within a common housing.

In one embodiment, the controller 114 may be coupled to a wire 120 that can transmit a signal from a button 118 located on the flexible curtain 102. The button 118 may be attached to one side of the curtain with an adhesive. However, the button 118 can be activated from either side of the flexible curtain 102. When, the button 118 is depressed, a signal may be transmitted over the wire 120 to the controller 114 to activate the motor 116. The motor 116 may cause the shaft 124 to rotate. The rotation of the shaft 124 in a first direction may cause the flexible curtain 102 to coil around the shaft 124. The rotation of the shaft 124 in a second direction, opposite of the first direction, may cause the flexible curtain 102 to uncoil from the shaft 124.

In one embodiment, the roll-up door 100 may also include a manual handle 122 on a second end 128 of the flexible curtain 102. The manual handle 122 may be located on both sides of the flexible curtain 102 to allow a user to open the flexible curtain 102 from either side. The manual handle 122 may allow a user to manually pull up the flexible curtain 102 to access the opening behind the flexible curtain 102.

In one embodiment, the flexible curtain 102 may include a plurality of buttons 112₁ to 112ₙ (hereinafter also referred to individually as a button 112 or collectively as buttons 112). In one embodiment, a first set of the buttons 112₁ to 112₈ may be located along a first edge 108 of the flexible curtain 102. A second set of the buttons 112₉ to 112ₙ may be located along a second edge 110 of the flexible curtain 102. The first edge 108 and the second edge 110 may be opposite one another. The first edge 108 may be held within the first guide assembly 104 by the buttons 112₁ to 112₈ (shown in dashed lines inside of the first guide assembly 104). The second edge 110 may be held within the second guide assembly 106 by the buttons 112₉ to 112ₙ (shown in dashed lines inside of the second guide assembly 106).

In one embodiment, the flexible curtain 102 may be fabricated from any type of material that can withstand temperatures up to 400 degrees Fahrenheit (° F.) with less than 0.7% shrinkage (e.g., original dimensions divided by dimensions when exposed to elevated temperatures). The flexible curtain 102 may be fabricated from a material that can have minimal dimensional change from moisture absorption and/or loss (e.g., less than 0.5% dimensional change).

In one embodiment, the flexible curtain 102 material may meet specifications in accordance with a standard. In an example, the testing method may be tensile strength at break in both the machine direction (MD) and transverse direction (TD) at 20,000 psi using ASTM D882A per the Melinex® ST725 specification. The testing method may also be for specific shrinkage values under the Melinex® ST725 specification. This test method may also be defined as “Unrestrained @ 150 degrees Celsius/30 minutes.”

The flexible curtain 102 material may be transparent or translucent. The flexible curtain 102 material may be able to accept ink printing and/or adhesive decals. The flexible curtain 102 material may be fabricated from a material that has a moderate to low friction coefficient.

In one embodiment, the flexible curtain 102 material may be strong enough to be resistant to punctures or tearing. The flexible curtain 102 material may be fabricated from a material that is available in wider widths in the transverse direction (e.g., at least 60 inches wide) or capable of being seamed together over a length (e.g., of 12 feet). In one example, the flexible curtain 102 material may be relatively rigid (e.g., having a thickness of between 7 mils to 10 mils or 0.007 inches to 0.010 inches thick). However, the flexible curtain 102 material may be capable of cycling (e.g., coiling and uncoiling) on the shaft 124, which may have a diameter of approximately 3 inches in diameter.

In one embodiment, the flexible curtain 102 material may be fabricated from a group of resins or plastics including polyester, polyetherimide, polyimide, polysulfone, polyethersulfone, or polyetheretherketone. In one embodiment, the flexible curtain 102 material may be fabricated from a polyester resin that results in a film with a thickness of approximately 10 mils or 0.010 inches and has a tensile strength in the machine direction (MD) of at least 20,000 pounds per square inch. An example of such a polyester film material is Melinex® ST725 (e.g., Dupont Tenjin Films). The fabric curtain 102 material may further comprise one or more layers of the same or different resin, including coatings on a monolayer film. The fabric curtain 102 material may be a laminate structure, including coatings the surface of the film. The fabric curtain 102 material may further comprise known additives such as plasticizers, surfactants, and other processing aids.

In one embodiment, due to the properties of the flexible curtain 102, the wire 120 may be located approximately in a center of the flexible curtain 102. For example, the wire 120 may be located approximately equidistant from the first edge 108 and the second edge 110 of the flexible curtain 102. As a result, when the flexible curtain 102 is coiled around the shaft 124, the flexible curtain 102 may be coiled evenly.

In one embodiment, the wire 120 may have a certain thickness. As a result, due to the thickness and rigid properties of the flexible curtain 102, the flexible curtain 102 may be unbalanced across the shaft 124 during coiling if the wire 120 is located off-center. The unbalance across the flexible curtain 102 may cause the flexible curtain 102 to coil unevenly up the first guide assembly 104 and the second guide assembly 106, causing a jam. Thus, having the wire 120 located approximately at the center of the flexible curtain 102 may prevent jams.

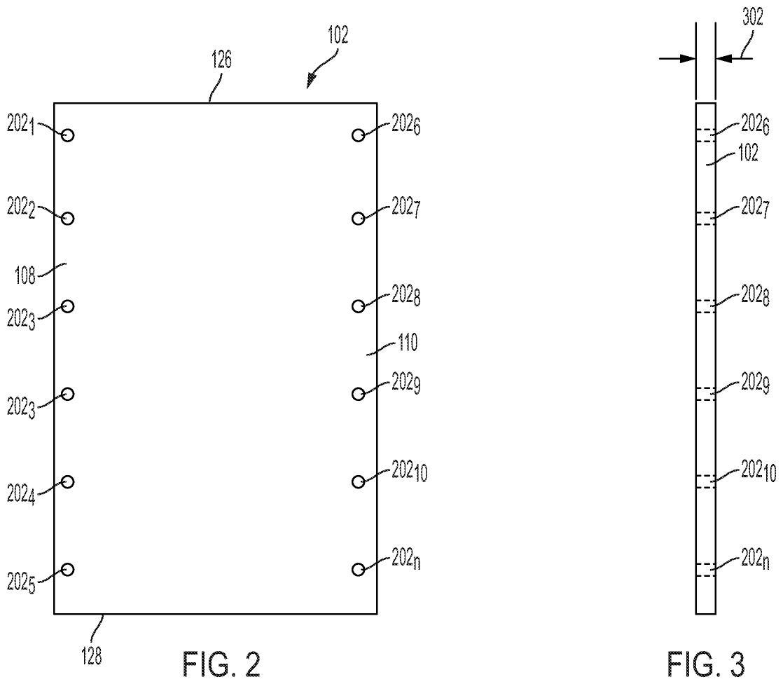

FIG. 2 illustrates a block diagram of a front view of an example of the flexible curtain 102. In one embodiment, the flexible curtain 102 may be fabricated with openings 202₁ to 202ₙ (hereinafter also referred to individually as an opening 202 or collectively as openings 202). In one embodiment, the openings 202₁ to 202₅ may be located along a first edge 108 of the flexible curtain 102. In one embodiment, the openings 202₆ to 202ₙ may be located along the second edge 110 of the flexible curtain 102.

It should be noted that although a certain number of openings 202 are illustrated along the first edge 108 and the second edge 110, the actual number of openings 202 along the first edge 108 and the second edge 110 may be equal to the number of buttons 112 located along the first edge 108 and the second edge 110. For example, if 10 buttons 112 are used on the first edge 108 and the second edge 110, then 10 openings 202 may be located along the first edge 108 and the second edge 110. Said another way, the total number of openings 202 may be equal to the number of buttons 112 that are used.

In one embodiment, the openings 202 may be intermittently spaced apart. In one embodiment, the openings 202 may be evenly spaced apart. In other words, the distance between the openings 202 (e.g., in a direction along the first edge 108 or the second edge 110) may be approximately equal.

In one embodiment, the openings 202 may allow the buttons 112 to be more quickly attached to the flexible curtain 102. In other words, the openings 202 may predetermine the location of the buttons 112 on the flexible curtain 102. As a result, the flexible curtain 102 and the buttons 112 may be assembled more efficiently and more quickly compared to other types of mechanisms to keep a flexible curtain within guides used on previously designed roll-up doors.

In one embodiment, the first edge 108 and the second edge 110 may be defined as a longest dimension of the flexible curtain 102. In one embodiment, the first edge 108 and the second edge 110 may be defined as the edges that are located within opposing guides that guide a direction of movement of the flexible curtain 102.

In one embodiment, the openings 202 may be located near the first edge 108 and the second edge 110. How close the openings 202 can be located to the first edge 108 and the second edge 110 may be a function of the tear strength of the material used to fabricate the flexible curtain 102. The stronger the material, the closer the openings 202 can be to the edges 108 and 110. In one embodiment, a distance from the center of each opening 202 to the first edge 108 or the second edge 110 can be approximately 0.1 inches to 0.5 inches. In one embodiment, the center of each opening 202 can be approximately 0.3125 inches from the first edge 108 or the second edge 110.

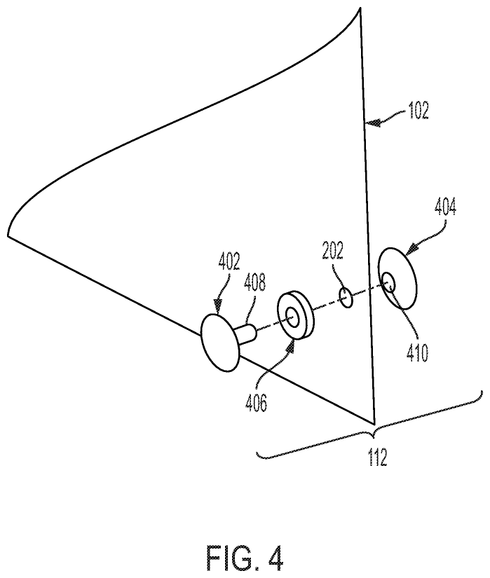

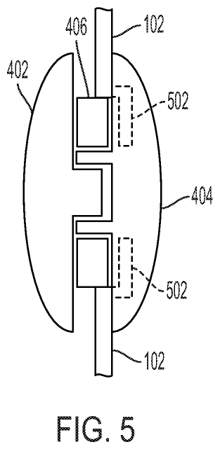

In one embodiment, a diameter of the openings 202 may be a function of a size of a member of the buttons 112 that is inserted through the openings 202. An example of the buttons 112 is illustrated in FIGS. 4 and 5, and discussed in further details below.

FIG. 3 illustrates a side view of an example of the flexible curtain 102. As noted above, the flexible curtain 102 material may have an average thickness 302 that is approximately 0.005 inches to 0.010 inches. The thickness 302 of the flexible curtain 102 material may provide some rigidity without tearing or cracking when rolled. The flexible curtain 102 material may also provide more strength and durability. For example, the flexible curtain 102 material may be durable in that the flexible curtain 102 material may age without cracking or discoloring. Moreover, the flexible curtain 102 film may be subjected to repeated tension events without substantial breaking, cracking, elongating, deforming, and the like. However, the flexible curtain 102 material may still be flexible enough to be coiled and uncoiled around the shaft 124.

FIG. 4 illustrates a block diagram of an exploded view of an example of the button 112. In one embodiment, the button 112 may be a two-piece rivet. The button may be fabricated from steel or metal.

In one example, a first piece 402 of the rivet may include an extended member 408. The second piece 404 may include an opening 410 to receive the extended member 408 of the first piece 402. The extended member 408 and the opening 410 may be mated via a friction fit, interlocking tabs, and the like, to secure the first piece 402 and the second piece 404 together. The coupling of the first piece 402 against the second piece 404 may provide a friction fit or clamping force against the flexible curtain 102.

In one embodiment, the extended member 408 may be inserted through the opening 202 of the flexible curtain 102 and into the opening 410 of the second piece 404. In one embodiment, the button 112 may also include a washer 406. The washer 406 may be located between the first piece 402 and the second piece 404 of the two button 112. The extend member 408 may pass through the opening of the washer 406 and the opening 202.

In one embodiment, the washer 406 may help to secure the flexible curtain 102 to the button 112. The washer 406 may help to provide more clamping force against the flexible curtain 102. A cross-sectional image of the button 112 illustrated in FIG. 5 helps to illustrate how the button 112 secures to the flexible curtain 102.

FIG. 5 illustrates a cross-sectional view of the button 112. In one embodiment, an inner edge 502 of the opening 202 may be clamped between a surface of the washer 406 and inner surface of the second piece 404. The inner edge 502 is illustrated as dashed lines inside of the second piece 404. The inner edge 502 may be stretched or slightly deformed as the inner edge 502 is trapped between the outer circumference of the opening 410 of the second piece 404 and the inner surface of the washer 406. Trapping the inner edge 502 against the washer 406 and the outer circumference of the opening 410 may help to create a clamping force to secure the flexible curtain 102 to the buttons 112.

The first piece 402 may be secured against the washer 406 and into the second piece 404. Thus, the button 112 may be secured against the inner edge 502 of the opening 202 of the flexible curtain 102. In one example, the diameter of the opening 202 may be slightly smaller than a diameter of the opening 410. As a result, as the opening 410 is pushed up through the washer 406, the washer 406 may push the inner edge 502 into or against the inner surface of the second piece 404.

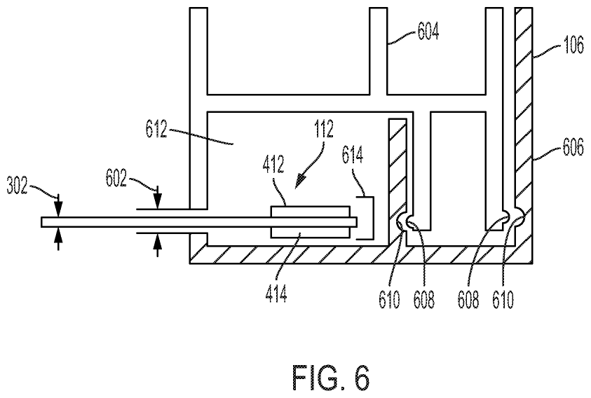

FIG. 6 illustrates a top view of the second guide assembly 106. However, it should be noted that the first guide assembly 104 may be similar to the second guide assembly 106, but a mirror image.

In one example, the second guide assembly 106 may be comprised of a first bracket 604 and a second bracket 606. The first bracket 604 may be coupled to a surface around the opening or elevator doors. The second edge 110 of the flexible curtain 102 with the buttons 112 may be inserted into a volume 612. The second bracket 606 may then be coupled to the first bracket 604 to enclose the second edge 110 with the buttons 112 into the volume 612 of the second guide assembly 106.

In one embodiment, the second bracket 606 may include a coupling feature 610 that mates with a coupling feature 608 of the first bracket 604. For example, the coupling feature 610 may be a groove and the coupling feature 608 may be a tab or fot that is inserted into the groove. The tab may snap into the groove. However, it should be noted that the coupling features 608 and 610 may include any type of complementary mechanical coupling.

In one embodiment, when the first bracket 604 and the second bracket 606 are coupled together, a gap 602 may be formed. The gap 602 may allow the flexible curtain 102 to move freely up and down the second guide assembly 106. The gap 602 may have a width that is larger than the thickness 302 of the flexible curtain 102, but smaller than an overall average thickness 614 of the button 112. For example, the gap 602 may be approximately 0.050 inches wide, and the overall thickness 614 of the button 112 may be approximately 0.150 to 0.200 inches.

In one embodiment, the outer surfaces 412 and 414 of the button 112 (e.g., the outer surfaces of the first piece 402 and the second piece 404) may have a dome shape, as shown in FIG. 5. In one embodiment, the outer surfaces 412 and 414 of the button 112 may be attached to the flexible curtain 102 with a significant amount of pressure to compress the button 112 down to a desired thickness. As a result, the outer surfaces 412 and 414 of the button 112 may also be relatively flat, as shown in FIG. 6. The outer surfaces 412 and 414 may also be smooth. As a result, the shape and smoothness of the outer surfaces 412 and 414 may allow the button 112 to minimize friction against the inner surfaces of the second guide assembly 106 as the flexible curtain 102 is coiled and uncoiled.

Thus, the present disclosure provides a roll-up door 100 that has a flexible curtain 102 fabricated with materials that exhibit improved qualities over commercially available roll-up doors.

In addition, the roll-up door 100 provides an improved mechanism to secure the flexible curtain 102 in the first guide assembly 104 and the second guide assembly 106. The buttons 112 of the present disclosure can be quickly coupled to the flexible curtain 102 due to the pre-fabricated or pre-defined openings 202. In addition, the buttons 112 may reduce the overall costs of materials used compared to other guides that ran along an entire length of the edges of previous curtain designs.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A roll-up door, comprising:
a shaft;
a flexible curtain, wherein a first end of the flexible curtain is coupled to the shaft;
a plurality of buttons along a first edge and a second edge of the flexible curtain;
a first guide assembly to enclose the plurality of buttons along the first edge of the flexible curtain; and
a second guide assembly to enclose the plurality of buttons along the second edge of the flexible curtain, wherein the plurality of buttons is to guide movement of the flexible curtain caused by rotation of the shaft.

2. The roll-up door of claim 1, wherein the flexible curtain comprises a transparent or translucent material.

3. The roll-up door of claim 1, wherein the flexible curtain comprises a thickness of approximately 0.010 inches.

4. The roll-up door of claim 1, wherein the flexible curtain comprises a material that shrinks less than 0.7% at temperatures up to 400 degrees Fahrenheit.

5. The roll-up door of claim 1, wherein the movement of the flexible curtain comprises coiling around the shaft or uncoiling around the shaft.

6. The roll-up door of claim 1, wherein the flexible curtain has a dimensional change of less than 0.5% from moisture absorption or loss.

7. The roll-up door of claim 1, wherein the flexible door comprises a material capable of accepting ink printing.

8. A roll-up door, comprising:
a shaft;
a flexible curtain comprising a thickness of between 0.007 inches to 0.010 inches, wherein a first end of the flexible curtain is coupled to the shaft;
a plurality of buttons along a first edge and a second edge of the flexible curtain;
a first guide assembly to enclose the plurality of buttons along the first edge of the flexible curtain; and
a second guide assembly to enclose the plurality of buttons along the second edge of the flexible curtain, wherein the plurality of buttons is to guide movement of the flexible curtain caused by rotation of the shaft.

9. The roll-up door of claim 8, wherein the flexible curtain comprises at least one of: polyester, polyetherimide, polyimide, polysulfone, polyethersulfone, or polyetheretherketone.

10. The roll-up door of claim 9, wherein the flexible curtain comprises polyester with a tensile strength of at least 20,000 pounds per square inch.

11. The roll-up door of claim 8, wherein the flexible curtain comprises a plurality of openings along the first edge of the flexible curtain and along the second edge of the flexible curtain.

12. The roll-up door of claim 11, wherein each one of the plurality of buttons is positioned at one of the plurality of openings along the first edge and the second edge of the flexible curtain.

13. The roll-up door of claim 8, wherein the first guide assembly comprises a first gap to allow a first edge of the flexible curtain to pass through and prevent the plurality of buttons along the first edge from escaping the first guide assembly.

14. The roll-up door of claim 8, wherein the second guide assembly comprises a second gap to allow a second edge of the flexible curtain to pass through and prevent the plurality of buttons along the second edge from escaping the second guide assembly.

15. A roll-up door, comprising:
a shaft;
a flexible curtain comprising a plurality of openings along a first edge and a second edge opposite the first edge, wherein a first end of the flexible curtain is coupled to the shaft;
a plurality of buttons along the first edge and the second edge, wherein each one of the plurality of buttons comprises a two-piece rivet, wherein the two-piece rivet is to grasp an inner edge of a respective opening of the plurality of openings;
a first guide assembly to enclose the plurality of buttons along the first edge of the flexible curtain; and
a second guide assembly to enclose the plurality of buttons along the second edge of the flexible curtain, wherein the plurality of buttons are to guide movement of the flexible curtain caused by rotation of the shaft.

16. The roll-up door of claim 15, further comprising:
a motor coupled to the shaft;
a controller coupled to the motor; and
a button communicatively coupled to the controller via a wire located at a center of the flexible curtain, wherein the controller is to activate the motor in response to a signal detected from the button that is communicatively coupled to the controller.

17. The roll-up door of claim 15, wherein each one of the plurality of buttons further comprises a washer.

18. The roll-up door of claim 17, wherein a first piece of the two-piece rivet comprises an inner tube member that is inserted into the respective opening.

19. The roll-up door of claim 18, wherein the inner edge of the respective opening is trapped between the washer and an inner surface of the second piece of the two-piece rivet.

20. The roll-up door of claim 15, wherein outer sides of the two-piece rivet comprise a smooth surface to minimize friction when moving against the first guide assembly and the second guide assembly as the flexible curtain is moved by the rotation of the shaft.
